(19) United States
(12) Patent Application Publication
(10) Pub. No.: US 2003/0186190 A1
(43) Pub. Date: Oct. 2, 2003

(54) Dispenser for dental filling material

(76) Inventors: Saumil Lokhandwala, Hayward, CA (US); Manu Makhija, Castro Valley, CA (US)

Correspondence Address: DERGOSITS & NOAH LLP, Four Embarcadero Center, Suite 1450, San Francisco, CA, 94111, US

(21) Appl. No.: 10/109,461

(22) Filed: Mar. 26, 2002

(51) Int. Cl. A61C 5/04

(52) U.S. Cl. 433/89

(57) ABSTRACT

A dispenser for dental filling material has an elongate body with an interior bore and a first opening into the interior bore at the front end of the body. The interior bore has a narrower bore portion in the front end of the body and a wider bore portion in the back end of the body, and dental filling material is placed within the narrower bore portion. A plunger is positioned in the interior bore and has a head portion sized to fit snugly within the narrower bore portion. The plunger also has a tail portion positioned within the wider portion. A lever is pivotally coupled to the body and includes a distal end inserted through a second opening in the body. The lever is operable over a small range of motion to ratchet the plunger forward toward the front end of the body such that the head portion is pushed into the narrower bore portion thereby expelling dental filling material through the first opening.

### TECHNICAL FIELD

The invention relates to a molded plastic apparatus for dispensing dental filling material.

### BACKGROUND OF THE INVENTION

Various types of syringes and dispensers are known, including several used for dispensing dental filling material. For example, U.S. Pat. No. 4,472,141 discloses an all purpose dental syringe having trigger-type power handle. A plunger is positioned inside a barrel assembly and coupled to the handle such that the plunger is incrementally advanced upon actuation of the power handle. U.S. Pat. No. 6,062,857 also discloses a gun-type dispenser for dental material, wherein a plunger or piston is actuated by a trigger handle to forcably eject dental material from a cartridge inserted into the barrel. Other variations are disclosed in the following U.S. Pat. Nos. 6,047,864; No. 4,738,664; No. 5,061,179; and No. 5,125,836.

However, each of these devices suffers from being overly complex and therefore too expensive to manufacture as a useful and disposable consumer product. It would be desirable to provide an improved dispenser for temporary filling material that is simple and inexpensive to manufacture yet convenient and easy to use.

### SUMMARY OF THE INVENTION

The present invention is a dispenser for dental filling material. Three components are individually molded of plastic material and then assembled into an integral unit. The individual molded components are a body, a plunger and a lever. The body is elongate with an interior bore, including a narrower bore portion in the front end of the body and a wider bore portion in the back end of the body. A first opening into the narrower bore portion is located at the front end of the body such that dental filling material stored within the narrower bore portion can be expelled from the first opening. The body also includes a first set of teeth formed in the wider bore portion

A plunger is positioned in the interior bore and has a head portion sized to fit snugly within the narrower bore portion for the purpose of pushing the dental filling material out of the first opening. The plunger also has a tail portion positioned within the wider portion. The tail portion has a second set of teeth adapted to mate with the first set of teeth. The first and second sets of teeth are oriented such that the plunger can be advanced toward the front end of the body, but will not move backwards after being advanced. The tail portion also has a third set of teeth adapted for cooperation with the lever.

The lever is pivotally coupled to the body and has a distal end inserted through a second opening in the body. The distal end of the lever includes a finger which engages at least one of the third set of teeth on the tail portion of the plunger. The lever is operable over a small range of motion. When operated, the finger pushes on the third set of teeth to ratchet the plunger forward toward the front end of the body such that the head portion is pushed into the narrower bore portion thereby expelling dental filling material through the first opening. On the return stroke of the lever, caused by the plastic spring action of the lever, the lever finger hits the rear face of the third set of teeth on the plunger. This causes the middle portion of the plunger to deflect downward, hence the lever finger slips in front of the next teeth of the plunger. The lever is thus ready to be operated again for next stroke.

### BRIEF DESCRIPTION OF THE FIGURES

FIG. 1 is a side plan view of a dispenser for dental filling material in accordance with the present invention.

FIG. 2 is a similar view of the dispenser providing dimensional references.

### DETAILED DESCRIPTION OF THE INVENTION

The present invention is intended to provide a convenient, easy-to-use dispenser for temporary filling material so that an individual may obtain temporary relief from the problems associated with dental cavities until professional care can be sought. Well known plastic molding techniques are used to create several discrete components that can be easily assembled into an integral unit, which is then packaged and sold for consumer use. The basic components of the assembled unit are: (1) a body having an interior bore, (2) a plunger fitted within the bore and adapted to be ratcheted forward in the bore to push dental filling material through a hole in the front of the body, and (3) a lever having a latch portion extending into the bore and coupled to the plunger and a handle portion extending out from the body and operable over a small range of movement to actuate the plunger and push it forward in the body, thereby dispensing filling material from the front end thereof.

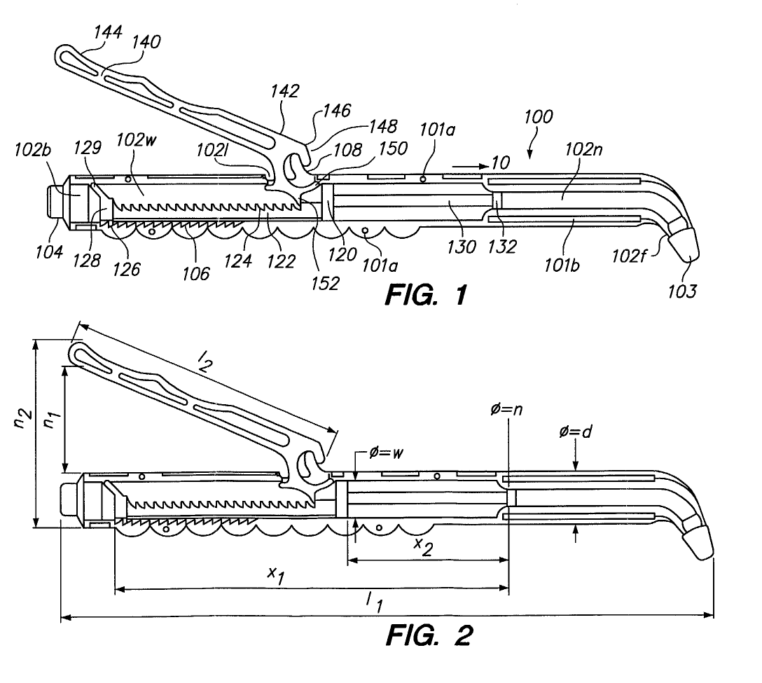

The preferred embodiment of the invention is illustrated in FIG. 1. The body 100 is generally cylindrical in shape and formed to have a hollow internal bore 102 with a wider portion 102w (i.e., larger diameter) in the back of the body and a narrower portion 102n (i.e., smaller diameter) in the front of the body. The body is preferably a rigid plastic material, such as acrylonitrile butadiene styrene (“ABS”), formed using a conventional process in two halves (only one half shown) to have typical dimensions as shown in Table I below. The two halves are ultrasonically welded together and then the internal components are affixed in place. In order to facilitate accurate bonding of the halves, registration features such as bumps 101a and ridges 101b (with corresponding recesses in the other half for receiving the bumps and ridges) are advantageously provided on one or both surfaces of the facing halves to accurately align and secure the halves to one another.

The body 100 is also molded to have a set of teeth 106 in a sawtooth arrangement protruding from the bottom of the wider portion 102w. These teeth 106 are provided in a fixed position and designed so that the plunger 120 can be ratcheted forward in the bore 102, as described below, and prevented from reverse movement. Thus, the rear of each tooth portion is a vertical face to prevent rearward movement, and the front of each tooth portion is an angled face (approximately 45 degrees) so that the teeth 126 on the plunger 120 can travel over the angled face and settle into the next tooth portion.

The wider portion 102w of the bore is adapted to receive the plunger 120. The plunger 120 is operably coupled to a lever 140, which is coupled to the plunger through opening 1021, in order to push dental filling material (not shown), which is stored in the narrower portion 102n of the bore, through front bore opening 102f, as will be further described below. A nub 108 extends from the body 100 adjacent to the opening 102l to provide a pivot for the lever 140.

A front cap 103 is fitted within the front bore opening 102f and is removed by hand in order to dispense filling material. A back cap 104 is fitted within the back bore opening 102b. The front cap and back cap are preferably formed of polypropylene in well known manner. Advantageously, the front cap 103 may be stored in a recess (not shown) formed in the back cap 104 while the apparatus is being used to dispense filling material. After the front cap 103 is replaced into the front opening 102f the front cap 103 may also be used to pack filling material into the dental cavity.

The plunger 120 includes a ratchet portion 122 and a pin portion 130 and is formed as a single integral component by conventional resin molding, for example, using an acetal resin. The ratchet portion 122 has a first set of teeth 124 in a sawtooth configuration extending from the top surface thereof. This first set of teeth 124 is ratcheted by operation of the lever mechanism 140 so that the plunger is pushed forward in the bore 102. The ratchet portion 122 also has a second set of teeth 126, preferably two teeth, extending downward from the back end 128 of the plunger to engage with corresponding teeth 106 on the body 100. A spring tab 129 extends upward from the back end 128 to maintain slight downward pressure on the plunger so that the teeth 126 on the plunger 120 remain engaged with the teeth 106 on the body. The resilience of the spring tab allows the plunger to be pushed forward by the ratcheting action of the lever 140 whereby the teeth 126 re-engage different teeth 106 on the body 100.

The pin portion 130 of the plunger 120 includes a head 132 formed to fit snugly within the narrower bore 102n and thereby push the dental material through the narrower bore and out of opening 102f as the plunger 120 is ratcheted forward.

The lever 140 includes a latch portion 142 and a handle portion 144. The handle portion 144 extends rearwardly at an angle (approximately 45 degrees). The latch portion 142 includes a hand portion 146 having a thumb 148 which hooks over the nub 108 and an index finger 150 which opposes the thumb on the inside of the bore 102. Further, a finger 152 extends from the hand into the teeth 124 on plunger 120. The lever 140 is preferably formed by conventional molding techniques, for example, acetal resin.

Referring now to FIG. 2, the dimensions of the preferred embodiment are as shown in Table I below:

TABLE I
Preferred Dimensions

| | | |
|---|---|---|
| Outside diameter | D | 0.420 inches |
| inside diameter - narrow bore | N | 0.140 inches |
| inside diameter - wide bore | W | 0.300 inches |
| Length of body | l₁ | 5.140 inches |
| Length of lever | l₂ | 2.170 inches |
| Length of plunger | x₁ | 3.100 inches |
| Length of pin | x₂ | 1.25 inches |
| Height to lever (outside) | h₁ | 0.760 inches |
| Height to lever (inside) | h₂ | 1.380 inches |

In operation, the front cap 102f is removed and advantageously placed in a hole or recess (not shown) located in the back cap 102b. The lever 140 is gently pushed downward thereby pivoting the finger 152 forward so as to push the teeth 124 (and therefore the plunger 120) forward into the bore 102 in the direction of arrow 10. As the plunger moves forward, the back end teeth 126 engage with teeth 106 to prevent rearward movement of the plunger. The head portion 132 of the plunger 120 pushes the dental material located in the narrower bore portion 102n through the front opening 102f.

When downward pressure on the lever is released, the lever moves back to its original position due to the resiliency of the material. The teeth 126 extending from the back end 128 of the plunger 120 are engaged with the teeth 106 on the body in such a way as to prevent rearward movement of the plunger. Thus, with each stroke of the lever, the plunger is advanced and locked against retreating, and a small metered amount of dental filling material is dispensed from the front opening. When the appropriate amount of dental filling material has been dispensed, the front cap can be replaced and used as a packing tool to pack the filling material into the patient's tooth.

While a preferred embodiment of the invention has been described, the scope of the invention is set forth in the claims.

1. A dispenser for dental filling material, comprising:
an elongate body having an interior bore and a first opening into the bore at a front end of the body, wherein the interior bore further comprises a narrower bore portion in the front end of the body, and wherein dental filling material is placed within the narrower bore portion,
a plunger affixed in the interior bore and having a head portion sized to fit snugly within the narrower bore portion and a tail portion, and
a lever coupled to plunger through a second opening in the body, said lever being operable over a small range of motion to advance the plunger toward the front end of the body such that the head portion is pushed into the narrower bore portion thereby expelling dental filling material from the narrower bore portion through the first opening.

2. A dispenser for dental filling material, comprising:
an elongate body having an interior bore and a first opening into the bore at a front end of the body, wherein the interior bore further comprises a narrower bore portion in the front end of the body and a wider bore portion in a back end of the body, and wherein dental filling material is placed within the narrower bore portion,
a plunger affixed in the interior bore and having a head portion sized to fit snugly within the narrower bore portion and a tail portion within the wider portion, and
a lever coupled to plunger through a second opening in the body, said lever being operable over a small range of motion to advance the plunger toward the front end of the body such that the head portion is pushed into the narrower bore portion thereby expelling dental filling material from the narrower bore portion through the first opening.

3. A dispenser for dental filling material as in claim 2, further comprising a front cap over the first opening.

4. A dispenser for dental filling material as in claim 2, wherein the body includes a first set of teeth disposed along the length of the wider bore portion, and wherein the plunger includes a second set of teeth disposed along the length of the tail portion in mating correspondence with the first set of teeth, and wherein operation of the lever causes the first and second sets of teeth to disengage and then re-engage in advanced positions such that the plunger is advanced toward the front end of the body.

5. A dispenser for dental filling material as in claim 2, wherein the plunger includes a third set of teeth disposed along the length of the tail portion and the lever includes a finger extending inside the second opending adapted for mating engagement with the third set of teeth.

6. A dispenser for dental filling material as in claim 2, wherein the body includes a nub adjacent the second opening, and wherein the lever is coupled to the nub for pivotal movement.

7. A dispenser for dental filling material, comprising:
an elongate body having an interior bore and a first opening into the interior bore at a front end of the body, wherein the interior bore further comprises a narrower bore portion in the front end of the body and a wider bore portion in the back end of the body, and wherein a plurality of body notches are provided in the wider bore portion,
a plunger positioned for linear movement within the interior bore, said plunger having a head portion which is sized to fit snugly within the narrower bore portion and a tail portion sized to fit within the wider portion, said tail portion having a plurality of plunger notches and a tab extending therefrom and adapted for mating engagement with at least one of the body notches, and
a lever pivotally coupled to the body and having a distal end inserted through a second opening in the body, said distal end of the lever having a finger adapted for mating engagement with at least one of the plunger notches,
wherein operating the lever causes the finger to push the plunger toward the front end of the body thereby pushing the head portion into the narrower bore portion and expelling dental filling material from the first opening, and the tab advances to another one of the body notches to retain the plunger in the advanced position.
